(19) United States
(12) Patent Application Publication
(10) Pub. No.: US 2013/0170213 A1
(43) Pub. Date: Jul. 4, 2013

(54) LIGHT-EMITTING DIODE MODULE

(71) Applicants: Shu-Juan HUANG, Hsin-Chu (TW); Cheng-Wei Chang, Hsin-Chu (TW); Te-Hen Lo, Hsin-Chu (TW)

(72) Inventors: Shu-Juan HUANG, Hsin-Chu (TW); Cheng-Wei Chang, Hsin-Chu (TW); Te-Hen Lo, Hsin-Chu (TW)

(73) Assignee: AU OPTRONICS CORP., Hsin-Chu (TW)

(21) Appl. No.: 13/633,305

(22) Filed: Oct. 2, 2012

(30) Foreign Application Priority Data
Dec. 30, 2011 (TW) 100150030

(51) Int. Cl. F21S 4/00

(52) U.S. Cl. 362/249.06

(57) ABSTRACT

An LED module includes a single-sided circuit board, a plurality of LED strings and signal wires. The single-sided circuit board has a surface defined with a first and second areas. A long edge of the surface has a wiring outlet located at a position corresponding to a boundary of the first and second areas. The LED strings are divided into a first and second groups disposed in the first and second areas, respectively. The signal wires each are disposed on the surface and routed to have its one end joined to the wiring outlet, and its another end electrically connected to a first end of one LED string or a second end of one LED string. In addition, some signal wires each are further routed to have a segment thereof passed through a gap formed between the two groups of LED strings.

### TECHNICAL FIELD

The disclosure relates to a display technical field, and more particularly to a light-emitting diode module (LED module) of a display apparatus.

### BACKGROUND

Basically LED modules employ, due to having limited trace routing spaces, doubled-sided boards (specifically, doubled-sided circuit boards). However, relative to the one-side board (specifically, single-sided circuit board), the doubled-sided board has a much higher manufacturing cost and thereby decreasing the associated product's competition. In addition, the doubled-sided board also has a relatively large thickness and accordingly is not applicable to those compact display apparatuses.

### SUMMARY OF EMBODIMENTS

Therefore, one object of the present disclosure is to provide an LED module employing single-sided boards.

An embodiment of the present disclosure provides an LED module, which includes a single-sided circuit board, a plurality of LED strings and a plurality of signal wires. The single-sided circuit board has a surface. The surface has a first long edge and a second long edge. The surface is defined with a first area and a second area. The first long edge has a wiring outlet at a position corresponding to a boundary of the first and second areas. The LED strings are divided into a first LED-string group and a second LED-string group. The first and second LED-string groups are disposed in the first and second areas, respectively. The signal wires are disposed on the surface and routed to have their one ends jointed to the wiring outlet. The signal wires are divided into a first wire group and a second wire group by the boundary of the first and second areas. A first signal wire in the first wire group is routed to have its another end electrically connected to one end of each LED string in the first LED-string group; and the remaining signal wires in the first wire group are routed to have their another ends electrically connected to another ends of the LED strings in the first LED-string group respectively. A second signal wire in the second wire group is routed to have its another end electrically connected to one end of each light-emitting diode string in the second LED-string group; and the rest signal wires in the second wire group are routed to have their another ends electrically connected to another ends of the LED strings in the second LED-string group respectively. Either the first signal wire or the rest signal wires in the first wire group each is further routed to have a segment thereof passed through a gap formed between the first and second groups of the LED strings.

Another embodiment of the present disclosure provides an LED module, which includes a circuit board, a plurality of LED strings and a plurality of signal wires. The circuit board has a surface. The surface has a first long edge and a second long edge. The surface is defined with a first area, a second area and a trace routing channel between the first and second areas. The first long edge has a wiring outlet at a position corresponding to the trace routing channel. The LED strings are divided into a first LED-string group and a second LED-string group. The first and second LED-string groups are disposed in the first and second areas, respectively. The signal wires are disposed on the surface and routed to have their one ends jointed to the wiring outlet. The signal wires are divided into a first wire group and a second wire group, and the first and second wire groups are adjacent to each other. A first signal wire in the first wire group is routed to have its another end electrically connected to one end of each LED string in the first LED-string group; and the remaining signal wires in the first wire group are routed to have their another ends electrically connected to another ends of the LED strings in the first LED-string group respectively. A second signal wire in the second wire group is routed to have its another end electrically connected to one end of each LED string in the second LED-string group; and the remaining signal wires in the second wire group are routed to have their another ends electrically connected to another ends of the LED strings in the second LED-string group respectively. Each of either the first signal wire or the remaining signal wires in the first wire group is further routed to have a segment thereof passed through the trace routing channel.

To sum up, in the LED module according to the present disclosure, a circuit board is divided into two areas or two areas and a trace routing channel on a surface thereof, the surface has a long edge designed to have a tracerouting outlet at a position corresponding to a boundary of the aforementioned areas of the trace routing channel. Moreover, a plurality of LED strings in the LED module are divided into two groups, which are disposed in the aforementioned two areas, respectively. Moreover, a plurality of signal wires associated with the LED module are disposed on the aforementioned surface. These signal wires are divided into two wire groups and are routed to have their one ends jointed to the tracerouting outlet. In the two wire groups each, one signal wire is routed to have its another end electrically connected to one end of each LED string in the group, and the rest signal wires in the same wire group are routed to have their another ends electrically connected to another ends of the LED strings in the same group respectively. Furthermore, either the signal wire, the one routed to have its one end electrically connected to one end of each LED string, or the rest signal wires in a same wire group each is further routed to have a segment thereof passed through a gap formed between the two groups of LED string or the tracerouting outlet. Thus, according to the aforementioned tracerouting, the circuit board in the LED module according to the present disclosure can be a signal-sided board.

### BRIEF DESCRIPTION OF THE DRAWINGS

The above embodiments will become more readily apparent to those ordinarily skilled in the art after reviewing the following detailed description and accompanying drawings, in which:

FIG. 1A is a schematic view of an LED module in accordance with an embodiment of the present disclosure;

FIG. 1B an alternative schematic view of the LED module 100 in accordance with the embodiment of the present disclosure;

FIG. 2 is a schematic view of an LED module in accordance with another embodiment of the present disclosure;

FIG. 3 is a schematic view of an LED module in accordance with still another embodiment of the present disclosure; and

FIG. 4 is a schematic view of an LED module in accordance with yet another embodiment of the present disclosure.

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

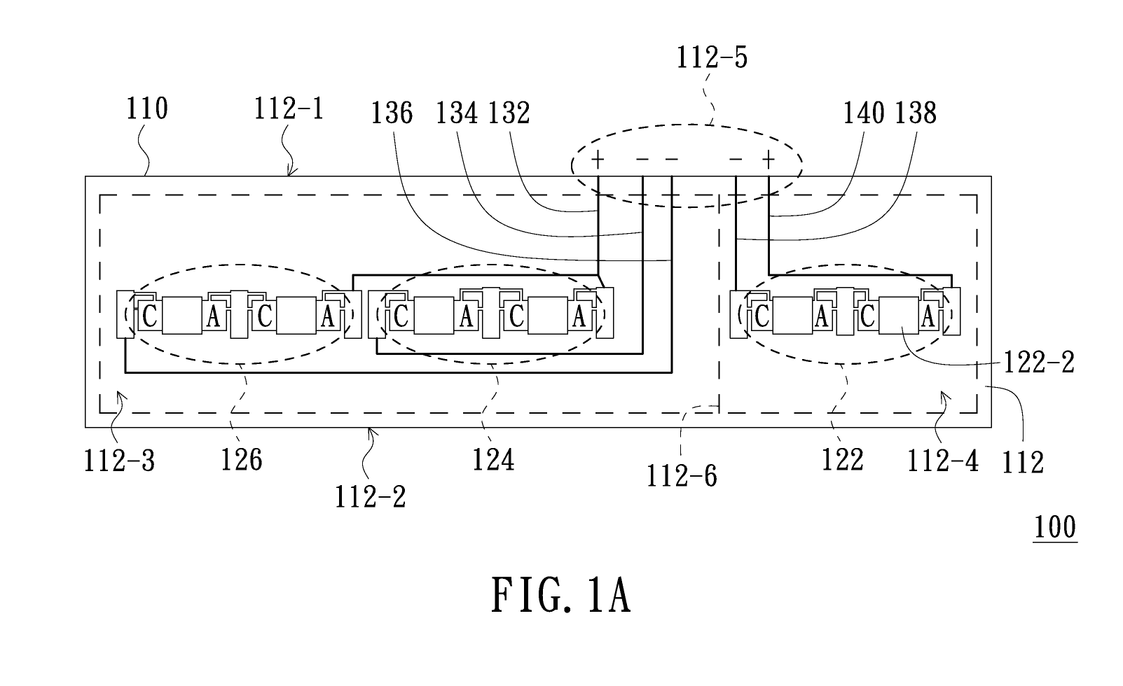

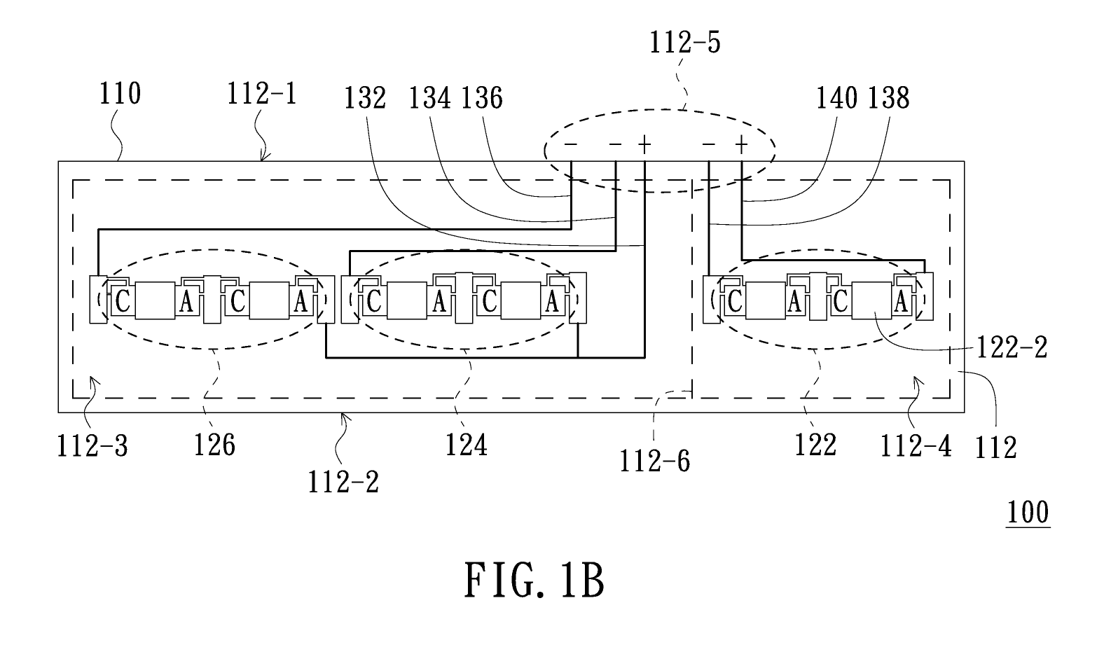

FIG. 1A is a schematic view of a light-emitting diode module (LED module) in accordance with an embodiment of the present disclosure. As shown, the LED module 100 includes a single-sided circuit board 110, a plurality of LED strings and a plurality of signal wires. In this embodiment, the LED module 100 herein is exemplified by including three LED strings 122, 124 and 126 and five signal wires 132, 134, 136, 138 and 140. In addition, the LED strings 122, 124 and 126 each include a plurality of LEDs 122-2 coupled in series, and each LED 122-2 has an electrode A (for example, anode) and an electrode C (for example, cathode). Specifically, these LEDs 122-2 are arranged to have their electrodes A aligned in a predetermined direction, which is parallel to, for example, a long edge 112-1; and no limitation.

The single-sided circuit board 110 has a surface 112. The surface 112 has two long edges 112-1, 112-2 and is defined with two areas 112-3, 112-4. The long edge 112-1 has a wiring outlet 112-5 at a position corresponding to a boundary 112-6 of the areas 112-3, 112-4. In addition, the three LED strings 122, 124 and 126 are divided into two LED-string groups and each LED-string group includes at least one LED string. In this embodiment, the LED strings 124, 126 belong to the first LED-string group, which is disposed in the area 112-3; and the LED string 122 belongs to the second LED-string group, which is disposed in the area 112-4.

The five signal wires 132, 134, 136, 138 and 140 are disposed on the surface 112 and are routed to have their one ends joined or coupled to the wiring outlet 112-5. In addition, the five signal wires 132, 134, 136, 138 and 140 are divided into two wire groups by the boundary 112-6 of the areas 112-3, 112-4 and each wire group includes at least one signal wire. In this embodiment, the signal wires 132, 134 and 136 belong to the first wire group, which is disposed in the area 112-3; and the signal wires 138, 140 belong to the second wire group, which is disposed in the area 112-4.

In the first wire group, the signal wire 132 is routed to have its another end electrically connected to one end of each LED string (for example, the LED string 124, 126) in the first LED-string group. In this embodiment, the signal wire 132 is, due to being configured to transmit a power voltage (designated by +), routed to have its another end electrically connected to the electrode A (or, anode) of the first-stage (or, the most right) LED 122-2 in the LED string 124 and the electrode A (or, anode) of the first-stage (or, the most right) LED 122-2 in the LED string 126.

The remaining signal wires (for example, the signal wires 134, 136) in the first wire group are routed to have their another ends electrically connected to another ends of the LED strings (for example, the LED string 124, 126) in the first LED-string group, respectively. In this embodiment, the signal wires 134, 136 are, due to both being configured to transmit a reference voltage (designated by −), routed to have their another ends electrically connected to the electrode C (or, cathode) of the last-stage (or, the most left) LED 122-2 in the LED string 124 and the electrode C (or, cathode) of the last-stage (or, the most left) LED 122-2 in the LED string 126, respectively. In addition, it is to be noted that the signal wires 134, 136 each are further routed to have a segment thereof passed through a gap formed between the first LED-string group and the second LED-string group.

In the second wire group, the signal wire 140 is routed to have its another end electrically connected to one end of each LED string (for example, the LED string 122) in the second LED-string group. In this embodiment, the signal wire 140 is, due to being configured to transmit a power voltage (+), routed to have its another end electrically connected to the electrode A (or, anode) of the first-stage (or, the most right) LED 122-2 in the LED string 122.

The remaining signal wires (for example, the signal wire 138) in the second wire group are routed to have their another ends electrically connected to another ends of the LED strings (for example, the LED string 122) in the second LED-string group, respectively. In this embodiment, the signal wire 138 is, due to being configured to transmit a reference voltage (−), routed to have its another end electrically connected to the electrode C (or, cathode) of the last-stage (or, the most left) LED 122-2 in the LED string 122.

According to the wiring pattern illustrated in the aforementioned embodiment as shown in FIG. 1A, it is apparent to those ordinarily skilled in the art that the LED module 100 according to the present disclosure can be also implemented by reversing the wiring pattern in the first wire group of the signal wires 132, 134 and 136. For example, as illustrated in FIG. 1B which is an alternative schematic view of the LED module 100 in accordance with the embodiment of the present disclosure, the signal wires 134, 136 each are routed without being passed through the gap formed between the first and second LED-string groups, and accordingly the signal wire 132 is routed to have a segment thereof passed through the aforementioned gap. Based on the same manner, it is understood that the signal wires 138 and/or 140 can be also routed to have a segment thereof passed through the aforementioned gap; and no limitation.

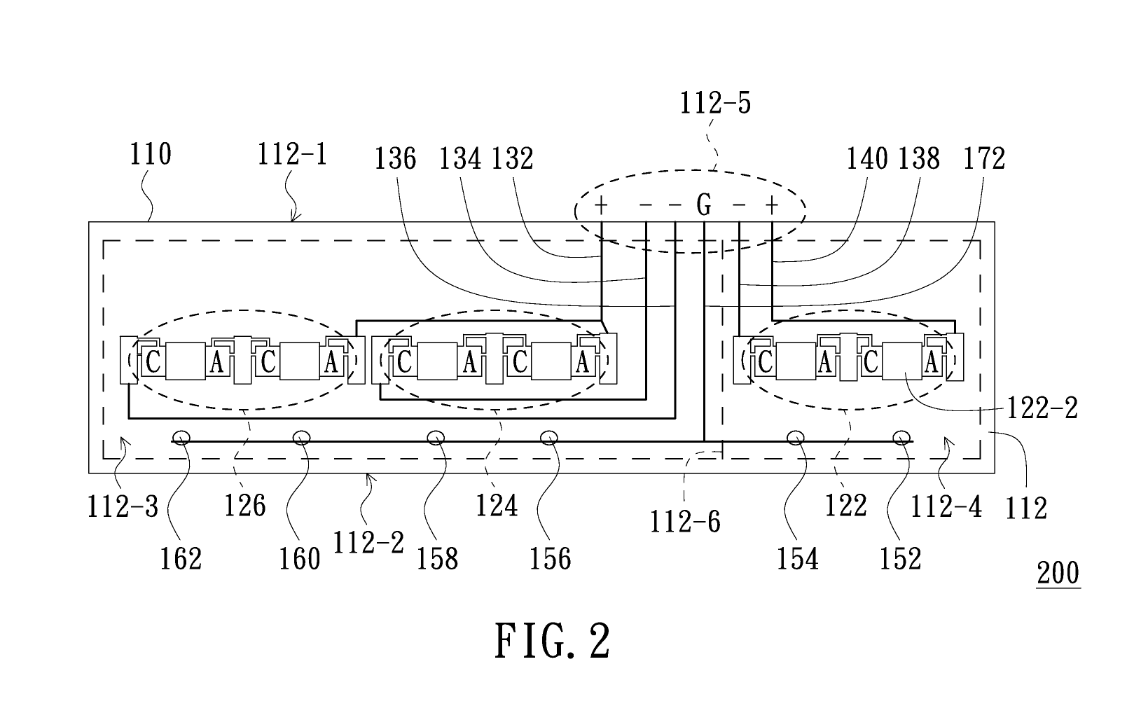

FIG. 2 is a schematic view of an LED module in accordance with another embodiment of the present disclosure. As shown, the LED module 200 in this embodiment has a structure similar to that of the LED module 100; and the main difference between the two embodiments is that the LED module 200 further includes a ground wire 172 and a plurality of ground points; wherein the LED module 200 herein is exemplified by including six ground points 152, 154, 156, 158, 160 and 162. Specifically, the six ground points 152, 154, 156, 158, 160 and 162 are sequentially disposed on the surface 112 and adjacent to the long edge 112-2, and each ground point is corresponding to one LED 122-2. In addition, the ground wire 172, configured to transmit a ground voltage G, is also disposed on the surface 112 and is routed to have its one end joined to the wiring outlet 112-5, specifically, joined between the first wire group (constituted by the signal wires 132, 134 and 136) and the second wire group (constituted by the signal wires 138, 140); its another end electrically connected to the ground points 152, 154, 156, 158, 160 and 162; and a segment thereof passed through the gap formed between the first LED-string group (constituted by the LED strings 124, 126) and the second LED-string group (constituted by the LED string 122).

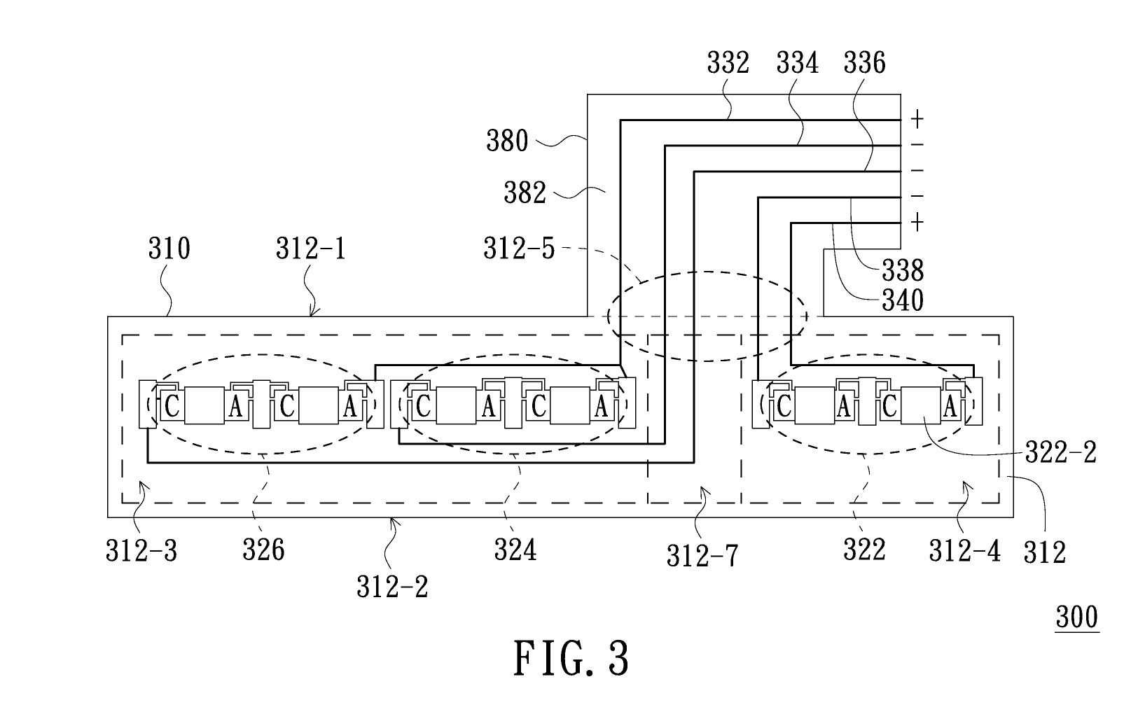

FIG. 3 is a schematic view of an LED module in accordance with still another embodiment of the present disclosure. As shown, the LED module 300 includes two circuit boards 310, 380, a plurality of LED strings and a plurality of signal wires. In this embodiment, the circuit boards 310, 380 each can be a single-sided circuit board; or, a multi-sided circuit board configured to be further disposed with other signal wires with other specific functions on other conductive layers thereof. In this embodiment, the LED module 300 herein is exemplified by including three LED strings 322, 324 and 326 and five signal wires 332, 334, 336, 338 and 340. In addition, the LED strings 322, 324 and 326 each include a plurality of LEDs 322-2 coupled in series, and each LED 322-2 has an electrode A (for example, anode) and an electrode C (for example, cathode). Specifically, these LEDs 322-2 are arranged to have their electrodes A aligned in a predetermined direction, which is parallel to, for example, a long edge 312-1 of a surface 312 of the circuit board 310; and no limitation.

The circuit board 380 has a surface 382. The surface 312 of the circuit board 310 has two long edges 312-1, 312-2 and is defined with two areas 312-3, 312-4 and a trace routing channel 312-7 located between the areas 312-3, 312-4. The long edge 312-1 has a wiring outlet 312-5 at a position corresponding to the trace routing channel 312-7. In addition, the three LED strings 322, 324 and 326 are divided into two LED-string groups, and each LED-string group includes at least one LED string. In this embodiment, the LED strings 324, 326 belong to the first LED-string group, which is disposed in the area 312-3; and the LED string 322 belongs to the second LED-string group, which is disposed in the area 312-4.

The five signal wires 332, 334, 336, 338 and 340 are disposed on the surfaces 312, 382 both, and each signal wire is routed to have a segment thereof passed through the wiring outlet 312-5. Compared with the five signal wires 132, 134, 136, 138 and 140 associated with the LED module 100 in FIG. 1A, the five signal wires 332, 334, 336, 338 and 340 associated with the LED module 300 in this embodiment are further routed to extend into the circuit board 380 via the wiring outlet 312-5. In addition, the five signal wires 332, 334, 336, 338 and 340 are divided into two adjacent wire groups and each wire group includes at least one signal wire. In this embodiment, the signal wires 332, 334 and 336 are divided to belong to the first wire group; and the signal wires 338, 340 are divided to belong to the second wire group.

In the first wire group, the signal wire 332 is routed to have its one end electrically connected to one end of each LED string (for example, the LED string 324, 326) in the first LED-string group. In this embodiment, the signal wire 332 is, due to being configured to transmit a power voltage (+), routed to have its one end electrically connected to the electrode A (or, anode) of the first-stage (or, the most right) LED 322-2 in the LED string 324 and the electrode A (or, anode) of the first-stage (or, the most right) LED 122-2 in the LED string 326.

The remaining signal wires (for example, the signal wires 334, 336) in the first wire group are routed to have their one ends electrically connected to another ends of the LED strings (for example, the LED string 324, 326) in the first LED-string group, respectively. In this embodiment, the signal wires 334, 336 are, due to both being configured to transmit a reference voltage (−), routed to have their one ends electrically connected to the electrode C (or, cathode) of the last-stage (or, the most left) LED 322-2 in the LED string 324 and the electrode C (or, cathode) of the last-stage (or, the most left) LED 322-2 in the LED string 326, respectively. In addition, it is to be noted that each of the signal wires 334, 336 is further routed to have a segment thereof passed through the trace routing channel 312-7.

In the second wire group, the signal wire 340 is routed to have its one end electrically connected to one end of each LED string (for example, the LED string 322) in the second LED-string group. In this embodiment, the signal wire 340 is, due to being configured to transmit a power voltage (+), routed to have its one end electrically connected to the electrode A (or, anode) of the first-stage (or, the most right) LED 322-2 in the LED string 322.

The remaining signal wires (for example, the signal wire 338) in the second wire group are routed to have their one ends electrically connected to another ends of the LED strings (for example, the LED string 322) in the second LED-string group, respectively. In this embodiment, the signal wire 338 is, due to being configured to transmit a reference voltage (−), routed to have its one end electrically connected to the electrode C (or, cathode) of the last-stage (or, the most left) LED 322-2 in the LED string 322.

According to the wiring patterns illustrated in the aforementioned embodiment, it is understood that the circuit boards 310, 380 in the LED module 300 of the present disclosure each can have a single-sided board design. In addition, according to the wiring pattern illustrated in the aforementioned embodiment as shown in FIG. 3, it is apparent to those ordinarily skilled in the art that the LED module 300 according to the present disclosure can be also implemented by reversing the trace or wire routing in the first wire group of the signal wires 332, 334 and 336. In other words, the signal wires 334, 336 each can be routed without being passed through the trace routing channel 312-7, and accordingly, the signal wire 332 is routed to have a segment thereof passed through the trace routing channel 312-7. Based on the same manner, it is understood that the signal wires 338 and/or 340 can be also routed to have a segment thereof passed through the trace routing channel 312-7; and no limitation. In addition, the circuit boards 310, 380 can be integrated into one single circuit board.

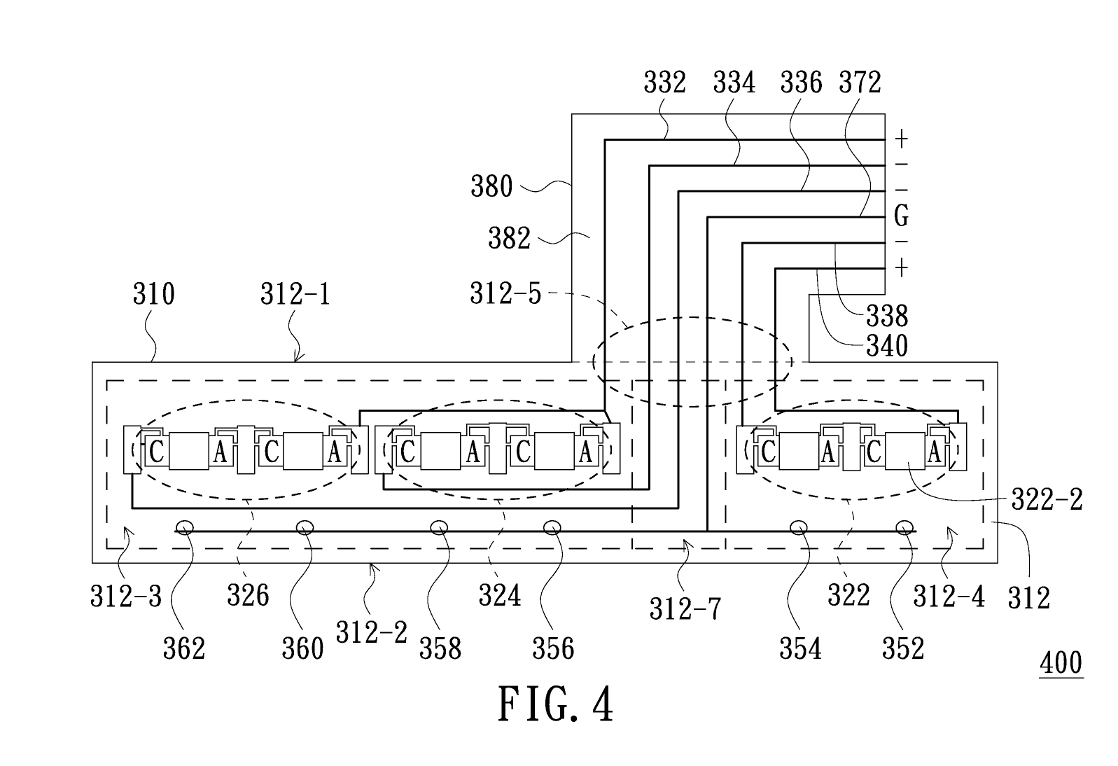

FIG. 4 is a schematic view of an LED module in accordance with yet another embodiment of the present disclosure. As shown, the LED module 400 in this embodiment has a structure similar to that of the LED module 300; and the main difference between the two embodiments is that the LED module 400 further includes a ground wire 372 and a plurality of ground points; wherein the LED module 400 herein is exemplified by including six ground points 352, 354, 356, 358, 360 and 362. Specifically, the six ground points 352, 354, 356, 358, 360 and 362 are sequentially disposed on the surface 312 and adjacent to the long edge 312-2, and each ground point is corresponding to one LED 322-2. In addition, the ground wire 372, configured to transmit a ground voltage G, is also disposed on the surface 312 and is routed to have a segment thereof passed through the wiring outlet 312-5, specifically, passing through between the first wire group (constituted by the signal wires 332, 334 and 336) and the second wire group (constituted by the signal wires 338, 340); its one end electrically connected to the ground points 352, 354, 356, 358, 360 and 362; and another segment thereof passed through the trace routing channel 312-7. In addition, compared with the five signal wires 132, 134, 136, 138 and 140 associated with the LED module 200 in FIG. 2, the five signal wires 332, 334, 336, 338 and 340 associated with the LED module 400 in this embodiment are further routed to extend into the circuit board 380 via the wiring outlet 312-5.

After reviewing the above detailed description and accompanying drawings, it is understood that the signal wires associated with the LED module according to the embodiments of the present disclosure are routed and configured to have a staggered arrangement. Specifically, the two signal wires located on the two sides of the wiring outlet are configured to transmit a power voltage (+) and the remaining signal wires located between the aforementioned two signal wires are configured to transmit a reference voltage (−); wherein the number of the signal wires joined to the wiring outlet is corresponding to that of the LED strings in the LED module.

Summarily, in the LED module according to the present disclosure, a circuit board is divided into two areas or two areas and a trace routing channel on a surface thereof, the surface has a long edge designed to have a wiring outlet at a position corresponding to a boundary of the aforementioned areas of the trace routing channel. Moreover, a plurality of LED strings in the LED module are divided into two groups, which are disposed in the aforementioned two areas, respectively. Moreover, a plurality of signal wires associated with the LED module are disposed on the aforementioned surface. These signal wires are divided into two wire groups and are routed to have their one ends joined to the wiring outlet. In each of the two wire groups, one signal wire is routed to have its another end electrically connected to one end of each LED string in the same LED-string group, and the remaining signal wires in the same wire group are routed to have their another ends electrically connected to another ends of the LED strings in the same LED-string group respectively. Furthermore, either the signal wire, which is the one routed to have its one end electrically connected to one end of each LED string, or each of the remaining signal wires in a same wire group is further routed to have a segment thereof passed through a gap formed between the two groups of LED string or the wiring outlet. Thus, according to the aforementioned wiring patterns, the circuit board in the LED module according to the embodiments of the present disclosure can be a signal-sided board.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light-emitting diode module, comprising:
a single-sided circuit board having a surface, the surface having a first long edge and a second long edge, and the surface being defined with a first area and a second area, the first long edge having a wiring outlet at a position corresponding to a boundary of the first and second areas;
a plurality of light-emitting diode (LED) strings divided into a first LED-string group and a second LED-string group, the first and second LED-string groups being disposed in the first and second areas, respectively; and
a plurality of signal wires disposed on the surface and routed to have their one ends joined to the wiring outlet, the signal wires being divided into a first wire group and a second wire group by the boundary of the first and second areas, a first signal wire in the first wire group being routed to have its another end electrically connected to one end of each LED string in the first LED-string group, the remaining signal wires in the first wire group being routed to have their another ends electrically connected to another ends of the LED strings in the first LED-string group respectively, a second signal wire in the second wire group being routed to have its another end electrically connected to one end of each LED string in the second LED-string group, the remaining signal wires in the second wire group being routed to have their another ends electrically connected to another ends of the LED strings in the second LED-string group respectively,
wherein each of either the first signal wire or the remaining signal wires in the first wire group is further routed to have a segment thereof passed through a gap formed between the first and second LED-string groups of the light-emitting diode strings.

2. The light-emitting diode module according to claim 1, wherein the one end of each signal wire joined to the wiring outlet further extends out from the wiring outlet.

3. The light-emitting diode module according to claim 1, wherein each LED string comprises a plurality of LEDs coupled in series.

4. The light-emitting diode module according to claim 3, wherein each of the LEDs comprises a first electrode and a second electrode, and the LEDs are arranged to have the first electrodes aligned in a predetermined direction.

5. The light-emitting diode module according to claim 4, wherein the predetermined direction is parallel to the first long edge.

6. The light-emitting diode module according to claim 3, further comprising:
a plurality of ground points sequentially disposed on the surface and adjacent to the second long edge, and each ground point being corresponding to one light-emitting diode (LED); and
a ground wire disposed on the surface and routed to have its one end joined to the wiring outlet and specifically located between the first and second wire groups, its another end electrically connected to the ground points, and a segment thereof passed through the gap formed between the first and second LED-string groups of the LED strings.

7. The light-emitting diode module according to claim 6, wherein the one end of the ground wire joined to the wiring outlet further extends out from the wiring outlet.

8. The light-emitting diode module according to claim 1, wherein the first and second signal wires each are configured to transmit a power voltage, the remaining signal wires in the first and second wire groups each are configured to transmit a reference voltage.

9. A light-emitting diode module, comprising:
a circuit board having a surface, the surface having a first long edge and a second long edge, and the surface being defined with a first area, a second area and a trace routing channel between the first and second areas, the first long edge having a wiring outlet at a position corresponding to the trace routing channel;
a plurality of light-emitting diode (LED) strings divided into a first LED-string group and a second LED-string group, the first and second LED string groups being disposed in the first and second areas, respectively; and
a plurality of signal wires disposed on the surface and routed to have their one ends joined to the wiring outlet, the signal wires being divided into a first wire group and a second wire group, the first and second wire groups being adjacent to each other, a first signal wire in the first wire group being routed to have its another end electrically connected to one end of each light-emitting diode string in the first LED-string group, the remaining signal wires in the first wire group being routed to have their another ends electrically connected to another ends of the light-emitting diode strings in the first LED-string group respectively, a second signal wire in the second wire group being routed to have its another end electrically connected to one end of each light-emitting diode string in the second LED-string group, the remaining signal wires in the second wire group being routed to have their another ends electrically connected to another ends of the light-emitting diode strings in the second LED-string group respectively,
wherein each of either the first signal wire or the remaining signal wires in the first wire group is further routed to have a segment thereof passed through the trace routing channel.

10. The light-emitting diode module according to claim 9, wherein the one end of each signal wire joined to the wiring outlet further extends out from the wiring outlet.

11. The light-emitting diode module according to claim 9, wherein each LED string comprises a plurality of LEDs coupled in series.

12. The light-emitting diode module according to claim 11, wherein the LEDs each comprise a first electrode and a second electrode, and the LEDs are arranged to have the first electrodes aligned in a predetermined direction.

13. The light-emitting diode module according to claim 12, wherein the predetermined direction is parallel to the first long edge.

14. The light-emitting diode module according to claim 11, further comprising:
a plurality of ground points sequentially disposed on the surface and adjacent to the second long edge, and each ground point being corresponding to one of the LEDs; and
a ground wire disposed on the surface and routed to have one end of the ground wire joined to the wiring outlet, and specifically located between the first and second wire groups, another end of the ground wire electrically connected to the ground points, and a segment thereof passed through the trace routing channel.

15. The light-emitting diode module according to claim 14, wherein the one end of the ground wire joined to the wiring outlet further extends out from the wiring outlet.

16. The light-emitting diode module according to claim 9, wherein the first and second signal wires each are configured to transmit a power voltage, the remaining signal wires in the first and second wire groups each are configured to transmit a reference voltage.
